(19) United States
(12) Patent Application Publication
(10) Pub. No.: US 2024/0141141 A1
(43) Pub. Date: May 2, 2024

(54) SILOXANE/SILICONE COMPOSITIONS FOR USE IN ENHANCING POLYMER PROCESSING

(71) Applicant: TECHMER PM, Clinton, TN (US)

(72) Inventors: Anthony Kuo CHANG, Clinton, TN (US); Bhushan Janardan DESHPANDE, Clinton, TN (US); Rodney Malone WEAVER, Clinton, TN (US)

(73) Assignee: TECHMER PM, Clinton, TN (US)

(21) Appl. No.: 18/498,985

(22) Filed: Oct. 31, 2023

Related U.S. Application Data
(60) Provisional application No. 63/421,020, filed on Oct. 31, 2022.

(51) Int. Cl. C08K 9/04; C08L 23/06; C08L 23/12

(52) U.S. Cl. CPC C08K 9/04; C08L 23/06; C08L 23/12; C08K 2201/012; C08L 2201/08; C08L 2205/06; C08L 2207/066

(57) ABSTRACT

A non-fluorinated polymer processing aid composition comprises an organo-modified siloxane, a synergist, an antioxidant, and a carrier resin. The composition may be useful for improving polymer processing during film production by reducing sharkskin and die buildup.

### CROSS-REFERENCE TO RELATED APPLICATIONS

This application claims the benefit of U.S. provisional application Ser. No. 63/421,020 filed Oct. 31, 2022, the disclosure of which is hereby incorporated in its entirety by reference herein.

### TECHNICAL FIELD

The present disclosure generally relates to the use of silicone and/or siloxane materials in polymer process aids to reduce sharkskin and die lip build-up in film manufacturing.

### BACKGROUND

Plastics are ubiquitous in modern society, with uses in virtually every industry including food and agriculture, medicine, construction, consumer goods and the like. When manufacturing plastic films, technical issues can arise that affect the melt and flow characteristics of the polymers. Polymer processing aids have been used to reduce or avoid such issues. Polymer processing aids commonly include fluoropolymers and/or fluorelastomers. Such materials, however, are associated with environmental toxicity and adverse effects on human health. Accordingly, there is a need for polymer processing aids that function equally effectively without causing harm to the environment or to humans.

### BRIEF DESCRIPTION OF THE DRAWINGS

For a further understanding of the nature, objects, and advantages of the present disclosure, reference should be made to the following detailed description, read in conjunction with the following drawings, wherein like reference numerals denote like elements and wherein:

FIG. 1 shows an example of a suitable production set up in which the non-fluorinated PPA may be used to produce film.

FIG. 2 shows an example of film produced without using a PPA.

FIG. 3 shows an example of film produced using a standard fluorinated PPA.

FIG. 4 shows an example of film produced using an embodiment of the non-fluorinated PPA.

FIG. 5 shows a graph depicting the time to melt fracture elimination (0% melt fracture) without preconditioning for film produced with 1.5% (orange) or 3% (light blue) of a standard fluorinated PPA added, or 1.5% (brown) or 3% (grey) of an embodiment of the non-fluorinated PPA added.

FIG. 6 shows measurements of the time to melt fracture elimination (without line conditioning) for fluorinated versus non-fluorinated PPAs. The film was visually inspected upon coming out of the blown film line at various time intervals and compared to the control with no PPA added.

FIG. 7 shows a graph of the measurements of the percent pressure (without line conditioning) for fluorinated versus non-fluorinated PPAs. The percent pressure was measured at various time points throughout the run.

FIG. 8 shows the measurements from the experiment in FIG. 7 in chart form.

FIG. 9 shows measurements of the pressure reduction in the film machine with fluorinated versus non-fluorinated PPAs taken at various time points throughout the run.

FIG. 10 shows the reduction in pressure measurements from the experiment in FIG. 9 in chart form.

FIG. 11 shows measurements of pressure with line conditioning.

FIG. 12 shows the pressure measurements from the experiment in FIG. 11 in chart form.

FIG. 13 shows measurements of the reduction in pressure over the run time with line conditioning.

FIG. 14 shows the measurements of the reduction in pressure from the experiment in FIG. 13 in chart form.

FIG. 15 shows measurements of the time to melt fracture elimination with line conditioning.

FIG. 16 shows the results of a capillary rheology study performed at 200 degrees Celsius measuring viscosity versus shear rate.

FIG. 17 shows the results of a capillary rheology study performed at 220 degrees Celsius measuring apparent stress versus shear rate.

FIG. 18 shows the results of a study of die build up with white HDPE. The graph shows measurements of pressure taken at various time points during the run. PM1005E4 is 50% white with zinc stearate. TPM11166 is a fluorinated PPA, and PM125000 is an embodiment of the non-fluorinated PPA.

FIG. 19 shows the results shown in FIG. 18 in chart form.

FIG. 20 shows the time until die buildup for fluorinated versus non-fluorinated PPAs.

FIG. 21 shows images of die buildup over time when Control resin with no PPA is used.

FIG. 22 shows images of die buildup over time when 1% of a fluorinated PPA is used.

FIG. 23 shows images of die buildup over time when 1% of an embodiment of the non-fluorinated PPA is used.

FIG. 24 shows images of die buildup comparing the buildup observed with 1% of the fluorinated versus the non-fluorinated PPAs at 120 minutes.

FIG. 25 shows data for percent retention of tensile strength at break for film produced using the non-fluorinated PPA with a UV stabilizer included according to an embodiment.

FIG. 26 shows data for percent retention of elongation at break for film produced using the non-fluorinated PPA with a UV stabilizer included according to an embodiment.

FIG. 27 shows data for the thermal stability of the fluorinated PPA versus the non-fluorinated PPA according to an embodiment.

FIG. 28 shows properties of film produced with the non-fluorinated PPA according to an embodiment.

FIG. 29 shows properties of film produced with the non-fluorinated PPA with a slip agent included according to an embodiment.

### DETAILED DESCRIPTION

Reference will now be made in detail to presently preferred compositions, embodiments and methods of the present disclosure, which constitute the best modes of practicing the disclosure presently known to the inventors. The Figures are not necessarily to scale. However, it is to be understood that the disclosed embodiments are merely exemplary of the disclosure that may be embodied in various and alternative forms. Therefore, specific details disclosed herein are not to be interpreted as limiting, but merely as a representative basis for any aspect of the disclosure and/or as a representative basis for teaching one skilled in the art to variously employ the present disclosure.

Except in the examples, or where otherwise expressly indicated, all numerical quantities in this description indicating amounts of material or conditions of reaction and/or use are to be understood as modified by the word “about” in describing the broadest scope of the disclosure. Practice within the numerical limits stated is generally preferred. Also, unless expressly stated to the contrary: all R groups (e.g. Rᵢ where i is an integer) include hydrogen, alkyl, lower alkyl, C₁₋₆ alkyl, C₆₋₁₀ aryl, C₆₋₁₀ heteroaryl, alylaryl (e.g., C₁₋₈ alkyl C₆₋₁₀ aryl), —NO₂, —NH₂, —N(R′R″), —N(R′R″R″′)⁺L⁻, Cl, F, Br, —CF₃, —CCl₃, —CN, —SO₃H, —PO₃H₂, —COOH, —CO₂R′, —COR′, —CHO, —OH, —OR′, —O⁻M⁺, —SO₃⁻M⁺, —PO₃⁻M⁺, —COO⁻M⁺, —CF₂H, —CF₂R′, —CFH₂, and —CFR′R″ where R′, R″ and R″′ are C₁₋₁₀ alkyl or C₆₋₁₈ aryl groups, M⁺ is a metal ion, and L⁻ is a negatively charged counter ion; R groups on adjacent carbon atoms can be combined as —OCH₂O—; single letters (e.g., “n” or “o”) are 1, 2, 3, 4, or 5; in the compounds disclosed herein a CH bond can be substituted with alkyl, lower alkyl, C₁₋₆ alkyl, C₆₋₁₀ aryl, C₆₋₁₀ heteroaryl, —NO₂, —NH₂, —N(R′R″), —N(R′R″R″′)⁺L⁻, Cl, F, Br, —CF₃, —CCl₃, —CN, —SO₃H, —PO₃H₂, —COOH, —CO₂R′, —COR′, —CHO, —OH, —OR′, —O⁻M⁺, —SO₃⁻M⁺, —PO₃⁻M⁺, —COO⁻M⁺, —CF₂H, —CF₂R′, —CFH₂, and —CFR′R″ where R′, R″ and R″′ are C₁₋₁₀ alkyl or C₆₋₁₈ aryl groups, M⁺ is a metal ion, and L⁻ is a negatively charged counter ion; hydrogen atoms on adjacent carbon atoms can be substituted as —OCH₂O—; when a given chemical structure includes a substituent on a chemical moiety (e.g., on an aryl, alkyl, etc.) that substituent is imputed to a more general chemical structure encompassing the given structure; percent, “parts of,” and ratio values are by weight; the term “polymer” includes “oligomer,” “copolymer,” “terpolymer,” and the like; molecular weights provided for any polymers refers to weight average molecular weight unless otherwise indicated; the description of a group or class of materials as suitable or preferred for a given purpose in connection with the disclosure implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “about” means that the amount or value in question may be the specific value designated or some other value in its neighborhood. Generally, the term “about” denoting a certain value is intended to denote a range within +/−5% of the value. As one example, the phrase “about 100” denotes a range of 100+/−5, i.e. the range from 95 to 105. Generally, when the term “about” is used, it can be expected that similar results or effects according to the disclosure can be obtained within a range of +/−5% of the indicated value.

As used herein, the terra “and/or” means that either all or only one of the elements, of said group may be present. For example, “A and/or B” shall mean “only A, or only B, or both A and B”, in the case of “only A”, the terra also covers the possibility that B is absent, i.e. “only A, but not B”.

It is also to be understood that the present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter. When this phrase appears in a clause of the body of a claim, rather than immediately following the preamble, it limits only the element set forth in that clause; other elements are not excluded from the claim as a whole.

The phrase “composed of” means “including” or “consisting of.” Typically, this phrase is used to denote that an object is formed from a material.

With respect to the terms “comprising,” “consisting of,” and “consisting essentially of,” where one of these three terms is used herein, the presently disclosed subject matter can include the use of either of the other two terms.

The term “one or more” means “at least one” and the term “at least one” means “one or more.” The terms “one or more” and “at least one” include “plurality” and “multiple” as a subset. In a refinement, “one or more” includes “two or more.”

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

When referring to a numeral quantity, in a refinement, the term “less than” includes a lower non-included limit that is 5 percent of the number indicated after “less than.” For example, “less than 20” includes a lower non-included limit of 1 in a refinement. Therefore, this refinement of “less than 20” includes a range between 1 and 20. In another refinement, the term “less than” includes a lower non-included limit that is, in increasing order of preference, 20 percent, 10 percent, 5 percent, or 1 percent of the number indicated after “less than.”

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

For all compounds expressed as an empirical chemical formula with a plurality of letters and numeric subscripts (e.g., CH₂O), values of the subscripts can be plus or minus 50 percent of the values indicated rounded to or truncated to two significant figures. For example, if CH₂O is indicated, a compound of formula C_{(0.8-1.2)}H_{(1.6-2.4)}O_{(0.8-1.2)}. In a refinement, values of the subscripts can be plus or minus 30 percent of the values indicated rounded to or truncated to two significant figures. In still another refinement, values of the subscripts can be plus or minus 20 percent of the values indicated rounded to or truncated to two significant figures.

The term “metal” as used herein means an alkali metal, an alkaline earth metal, a transition metal, a lanthanide, an actinide, or a post-transition metal.

The term “extruder” as used herein means a machine used to extrude viscous substances, including but not limited to polymers, into high quality structured products by controlling the processing conditions.

The term “extrusion” as used herein means the process of forcing melted polymer pellets or granules through a die with an opening.

Throughout this application, where publications are referenced, the disclosures of these publications in their entireties are hereby incorporated by reference into this application to more fully describe the state of the art to which this disclosure pertains.

The following examples illustrate the various embodiments of the present disclosure. Those skilled in the art will recognize many variations that are within the spirit of the present disclosure and scope of the claims.

Polyethylene, which is currently the most common plastic in the world, was accidentally discovered in 1898 by the German chemist Hans von Pechmann when he heated diazomethane. Despite this and multiple rediscoveries, the industrial potential of polyethylene was not explored until 1933, when Eric Faucett and Reginald Gibson accidentally rediscovered it while conducting high pressure experiments on ethylene at Imperial Chemical Industries (ICI) in Norwich, CT.

The first plant began producing polyethylene in 1939, and the long chain, low density white polymer became hugely important to the war effort soon after. By this time, chemists had discovered that polyethylene could be extruded as film, and that coating wires and cables with this film led to enhanced performance. Additionally, polyethylene turned out to be a great insulator with low loss properties at very high frequency radio waves, leading to its use in submarine cables and radar applications.

In addition to plastic film, common uses for polyethylene include plastic bags, agricultural mulch, plastic bottles and containers, water pipes, housewares, and toys. It can also be used to produce medical prostheses, noise-reduction or anti-friction liners, and even fabric. The global polyethylene film market was valued at $82.6 billion in 2020 and is expected to reach $128.2 billion by 2030. Polyethylene films feature prominently in the food and beverage, agriculture, construction, household, and other such industries. The films can be categorized by the industry in which they are used. They can also be categorized by type, technology, or material. Stretch films and shrink films are the two main types of polyethylene films. The two technologies for polyethylene films are blown or cast film extrusion. The three main subcategories based on material are low-density polyethylene (LDPE), high-density polyethylene (HDPE), and linear low-density polyethylene (LLDPE).

To produce film, polymer resins of varying compositions are melted so that the plastic can be formed into the desired configuration. Particular characteristics of the resin used as well as the production methods can lead to issues with the polymer melt and/or flow characteristics, and consequently the quality of the end product. Polymer processing aids (PPAs) are additives that are combined with the polymer to improve the melt processability of the material. PPAs also improve the quality of the final product by removing flow marks and die lines. PPAs can be internal or external. Internal PPAs reduce friction within the polymer blend itself, thereby improving flow properties. External PPAs migrate to the surface of the polymer and reduce friction between the forming plastic and the metal machinery.

The improvement that PPAs provide to the polymer flow characteristics reduces the occurrence of melt fracture, die build up or gel formation. Melt fracture, which causes a roughening of the polymer surface, dubbed shark skinning, is caused by high stress at the die exit. Die build up occurs when material is deposited when exiting the die. This build up has to be cleaned, which leads to frequent production stoppages and therefore lost profit. Gel formation occurs from improper linking of the polymer molecules. By improving the overall flow characteristics, PPAs reduce the occurrence of gel formation.

Fluorinated PPAs have been widely utilized in plastic film production since the discovery that adding a small amount of fluoropolymers or fluoroelastomers to polyolephins resulted in a dramatic decrease in melt fracture and resulting processing issues. Fluorpolymers belong to a family of plastics in which fluorine molecules have replaced one or more hydrogen molecules. Over the last 50 years or so, fluoropolymers and fluoroelastomers or co-polymers thereof such as vinylidene fluoride (VF2) or hexafluorpropylene (HFP) have become the most commonly utilized materials in PPAs used in film production.

While fluoropolymers and fluoroelastomers are integral to the cost effectiveness and quality of plastic films, they are part of the group of compounds known as perfluoroalkyl and polyfluoroalkyl substances (PFAS). The PFAS perfluorooctanoic acid (PFOA) and perfluorooctane sulfonic acid (PFOS) were widely utilized in the United States from the 1940's until their use was phased out in 2016. The use of these chemicals in food contact applications is currently prohibited due to potential harmful effects on the environment and on human health. Despite these regulations, PFAS can be formed during manufacturing processes. For example, in 2021, PFOA was found to be unintentionally produced when high-density polyethylene containers used to store pesticides were fluorinated. Compositions containing or utilizing fluorine during processing therefore have the potential to produce these harmful compounds. As such, there is a need for PPAs that function similarly to fluorinated products but that do not contain PFAS or the potential for producing them.

Siloxane is a functional group having an inorganic backbone with the silicon-oxygen-silicon (Si—O—Si) linkage. Each silicon atom may carry two organic groups, typically methyl, ethyl, or phenyl groups. Siloxane polymers are called silicones. Siloxane polymers are ubiquitous in the modern world as they are components of many consumer products including pharmaceutical products, lotions and shampoos. Siloxane polymers can also be found in polyurethane cushions, paints and coatings, nautical sealants, aerospace equipment, dielectric barriers, and even cooking oil.

In at least one aspect, the present disclosure relates to fluorine-free masterbatch compositions comprising siloxane/silicone chemistry for use as an additive that functions to improve polymer processing. The compositions may be used as polymer processing aids (PPAs) to improve processing conditions during the production of blown film. The film may be linear low density polyethylene (LLDPE), high density polyethlene (HDPE), or the like. Hereinafter, the compositions will be referred to as the “Non-fluorinated PPAs”. The non-fluorinated PPAs may be free of fluorine and therefore do not have the potential for forming PFAS.

The non-fluorinated PPA may comprise siloxane-containing molecules or polymers, a synergist, an antioxidant, and a carrier resin. Non-limiting examples of siloxane-containing molecules or polymers include ultra-high molecular weight siloxane polymers, and organo modified siloxanes. Examples of suitable siloxane-containing molecules or polymers and organo-modified siloxanes and silanes are commercially available from Evonik, Dow Corning, and other chemical manufactures. Non-limiting examples of synergists include polyethylene glycol, polycaprolactone, and other suitable synergists. Non-limiting examples of antioxidants include phenolic antioxidants, tris(2,4-di-tert.-butylphenyl) phosphite, pentaerythritol tetrakis[3-[3,5-di-tert-butyl-4-hydroxyphenyl]propionate, octadecyl-3-(3′, 5′-di-tertbutyl-4′-hydroxyphenyl) propionate, phosphites, and other suitable antioxidants. The antioxidant may be included as a processing stabilizer. For example, a phosphite antioxidant may be included to protect the polymer during processing. Non-limiting examples of carrier resins include resins in the polyethylene family, such as LLDPE, LLDPE/Hexene, LDPE, HDPE, LLDPE-butene, LLDPE-octene, or polypropylene.

In at least one embodiment, the non-fluorinated PPA may comprise about 15 to 25 wt % of siloxane-containing molecules, in another embodiment about about 16.5 to 22.5 wt % of siloxane-containing molecules, and in yet another embodiment about 17 to 21 wt % of siloxane-containing molecules. For example, the non-fluorinated PPA may comprise about 15, 16, 17, 18, 19, 20, 21, 22, 23, 24, or 25 wt % of siloxane-containing molecules. In at least one embodiment, the non-fluorinated PPA may comprise about 15 to 25 wt % of organo modified siloxanes, in another embodiment about about 16.5 to 22.5 wt % of organo modified siloxanes, and in yet another embodiment about 17 to 21 wt % of organo modified siloxanes. In certain embodiments, the non-fluorinated PPA may comprise about 15, 16, 17, 18, 19, 20, 21, 22, 23, 24, or 25 wt % of organo modified siloxanes.

In at least one embodiment, the non-fluorinated PPA may comprise about 3 to 5 wt % of a synergist, in another embodiment about 3.25 to 4.75 wt % of a synergist, and in yet another embodiment about 3.5 to 4.5 wt % of a synergist. For example, the non-fluorinated PPA may comprise about 3, 3.5, 4.0, 4.5, or 5 wt % of a synergist.

In at least one embodiment, the non-fluorinated PPA may comprise about 0.01 to 0.20 wt % of an antioxidant, in another embodiment about 0.05 to 0.175 wt % of an antioxidant, and in yet another embodiment about 0.075 to 0.15 wt % of an antioxidant. For example, the non-fluorinated PPA may comprise about 0.01, 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, or 0.20 wt % of an antioxidant.

In at least one embodiment, the non-fluorinated PPA may comprise about 60 to 90 wt % carrier resin, in another embodiment about 65 to 85 wt % carrier resin, and in yet another embodiment about 70 to 80 wt % carrier resin. For example, the non-fluorinated PPA may comprise about 60, 61, 62, 63, 64, 65, 66, 67, 68, 69, 70, 71, 72, 73, 74, 75, 76, 77, 78, 79, 80, 81, 8, 83, 84, 85, 86, 87, 88, 89, or 90 wt % carrier resin. Examples of suitable carrier resins include but are not limited to polymeric resins including polyethylene-based resins such as LLDPE, LLDPE/Hexene, LDPE, HDPE, LLDPE-butene, LLDPE-octene, polypropylene, etc. The carrier resin may be of a similar resin family as the base resin. The carrier resin may have a higher flow rate than that of the base resin. A carrier resin that melts and flows more easily and quickly will exhibit more efficient and complete mixing with the base resin.

in at least one embodiment, the organo modified siloxanes and the synergist may be included in the non-fluorinated PPA in a weight ratio of from about 3:1 to about 6:1 of organo modified siloxanes to synergist, in another embodiment about 3.5:1 to 5.5:1 organo modified siloxanes to synergist, and in yet another embodiment about 4:1 to 5:1 organo modified siloxanes to synergist. For example, the organo modified siloxanes and the synergist may be included in a weight ratio of 3:1, 4:1, 5:1, or 6:1. In certain embodiments, including organo modified siloxanes and polyethylene glycol at a weight ratio between 4:1 and 5:1 may provide optimal processability and performance.

To generate the useable form of the non-fluorinated PPA, the components may be mixed together and heated. The mixture may then be subjected to shear via use of an extruder to promote uniform blending of the components. The heated mixture may be subjected to shear via use of a twin screw extruder, for example. The extruded mixture may then be cooled and formed into flakes, granules, powders, pellets, or other suitable masterbatch forms for use in film extrusion, or other suitable applications. The screw design, temperature, and RPM utilized during the processing of the non-fluorinated PPA may be altered to control the level of shear. The head pressure used during processing may be from 150 to 1800, or 200 to 1700, or 250 to 1600 psi. the amperage range used during processing may be from 9.5 to 12, or 10 to 11.75, or 10.5 to 11.5.

The non-fluorinated PPAs may be used during the production of monolayer or multilayer film. For multilayer film, the non-fluorinated PPAs may be used in the “Skin”, which consists of the outermost layers only. The non-fluorinated PPA may be used in either the top skin layer, the bottom skin layer, or both layers. For monolayer products, the non-fluorinated PPAs may be added in the form of flakes, granules, powders, pellets, or other suitable masterbatch forms during film production. For multilayer products, the non-fluorinated PPAs may be added in similar forms to the skin layer extrusion lines and not the cores. Alternatively, the non-fluorinated PPA may be added to one or more of the core layers and not to the skin layers. For applications where the PPAs may be useful in the skin layer, being able to add it to the skin layer alone may reduce costs as the PPA may be added only where it is needed.

The non-fluorinated PPAs may also be particularly useful for multi-layered films as layers of different resins may be added during construction of the film. For example, a small Nylon layer may be added in the core for a better barrier and puncture resistance. Adding different materials to distinct layers may increase the functionality of the film. For example, while Nylon may improve barrier properties and increase puncture resistance, producing the entire film with Nylon is more expensive and printing and sealing of films is more difficult with Nylon. Adding Nylon to just one layer confers the benefits of Nylon while reducing the risk of drawbacks associated with a film made entirely of Nylon.

The non-fluorinated PPAs may be used with base resins included but not limited to resins containing LLDPE, HDPE, or any resin from which sharkskin is expected. in at least one embodiment, the non-fluorinated PPAs may be added to base resins at a letdown ratio of about 0.5-3 weight percent, based on the total weight of the total composition, in another embodiment about 0.75-2.75 weight percent, and in yet another embodiment about 1-2.5 weight percent. For example, the non-fluorinated PPAs may be added at about 0.5, or at about 1.0, or about 1.5, or about 2.0, or about 2.5, or about 3 percent. A letdown ratio of 3% for example, means that the final mixture contains 3% of the non-fluorinated PPA and 97% of the base resin chosen by the user. It is recognized that the particular letdown ratio chosen may depend on the application. The chosen letdown ratio may also depend on the type of base resin and the film structure of the user. It is further recognized that letdown ratios of less than 0.5 percent will result in reduced performance, while high letdown ratios of greater than 6% for example, may cause build-up, affect clarity, induce other defects, or even result in deterioration of the physical properties of the film.

Base resins that are suitable for use with the non-fluorinated PPAs include but are not limited to polymeric resins including polyethylene-based resins (e.g., LLDPE, LLDPE/Hexene, LDPE, HDPE, LLDPE-butene, LLDPE-octene), polypropylene, and the like.

The film line may be pre-conditioned with the non-fluorinated PPAs prior to the start of film production. in at least one embodiment, the non-fluorinated PPA may be added to a film line for pre-conditioning at about 10-100 weight % for a small amount of time, in another embodiment at about 20-90 weight %, and in yet another embodiment about 30-85 weight percent. For example, the non-fluorinated PPA may be added to a film line at about 10, 15, 20, 25, 30, 35, 40, 45, 50, 55, 60, 65, 70, 75, 80, 85, 90, 95, or at about 100 percent. The remaining material may be the resin used to make the film. For example, when the non-fluorinated PPA is used at 10% to pre-condition the line, the pellet includes 10 wt % of the non-fluorinated PPA and 90 wt % of the resin to be used to make the film.

The non-fluorinated PPAs may be used with additives including but not limited to UV stabilizers, hindered light amine stabilizers (HALS) including secondary, tertiary, or —OCH₃ type HALS, UV absorbers, stearates, anti-static agents, whitening agents, slip agents, colorants, antiblocks, antifog, or the like. Suitable examples of each of the additives are described in more detail in Example 7. The additives may be included in the masterbatch composition of the non-fluorinated PPA or used along with the non-fluorinated PPA as a separate masterbatch or as an additive to the base resin. Any of the additives may be added alone or in combination with any other of the additives. For example, a non-fluorinated PPA according to an embodiment may comprise organo modified siloxanes, a synergist, an antioxidant, a carrier resin, a slip agent, and an antifog.

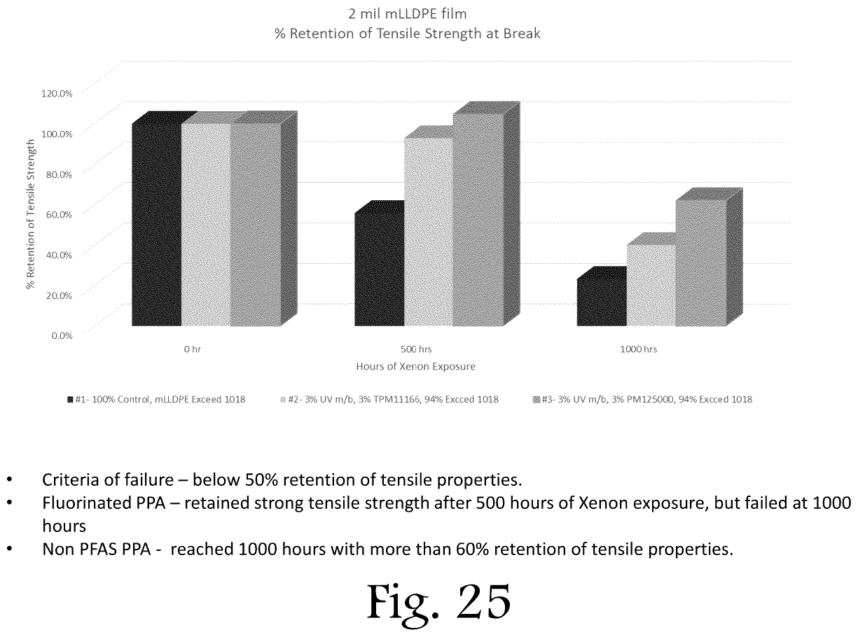

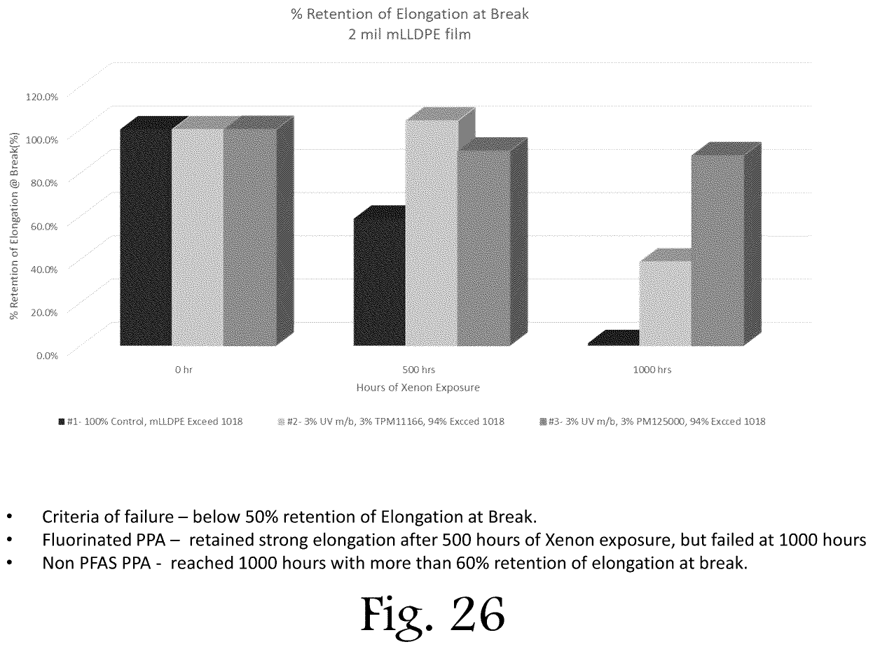

The non-fluorinated PPA may further comprise a UV stabilizer according to an embodiment. Referring to FIGS. 25 and 26, the non-fluorinated PPA with the UV stabilizer may increase retention of tensile strength and elongation as compared to resin without the PPA and also as compared to the fluorinated PPA. Tensile strength is the ability of a polymer to resist deformation when opposing loads are applied. Elongation at break measures the ductility of a polymer.

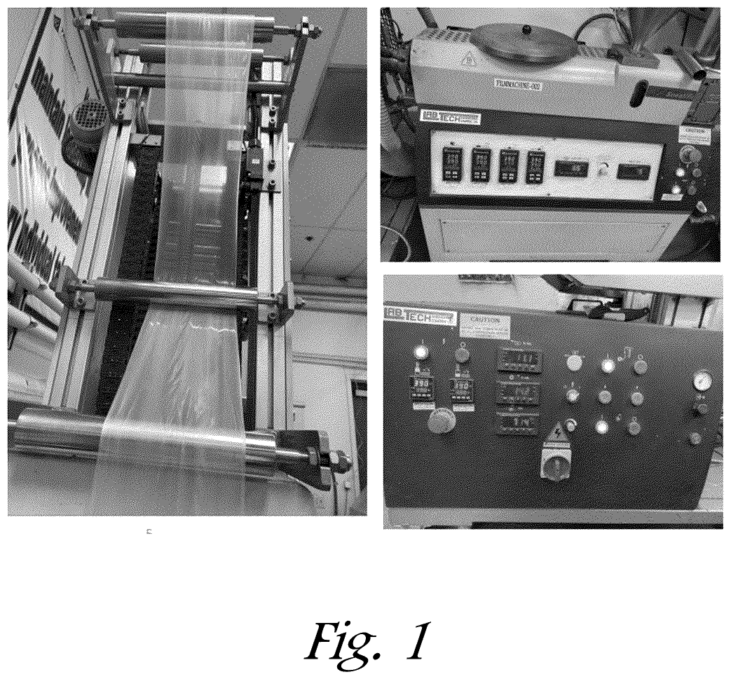

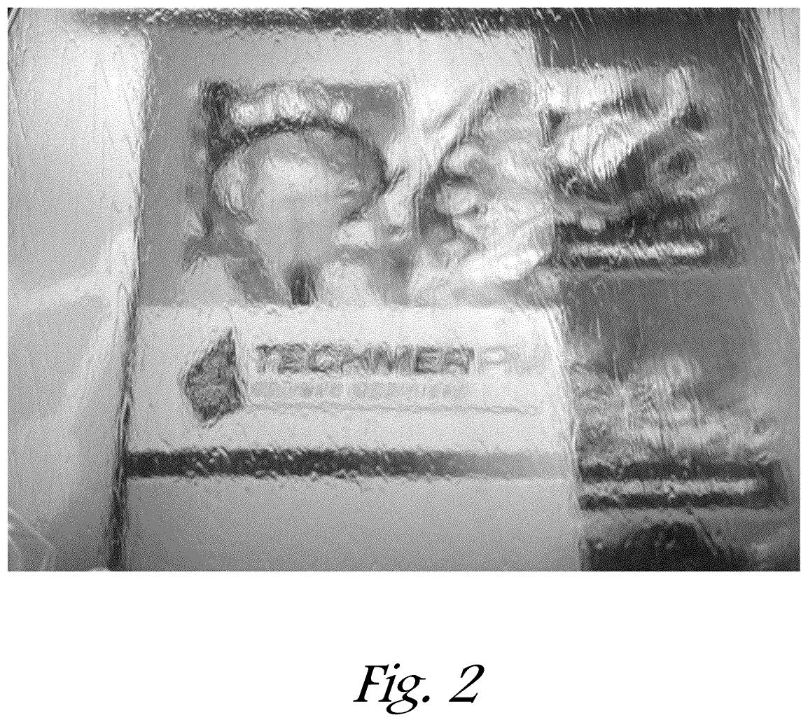

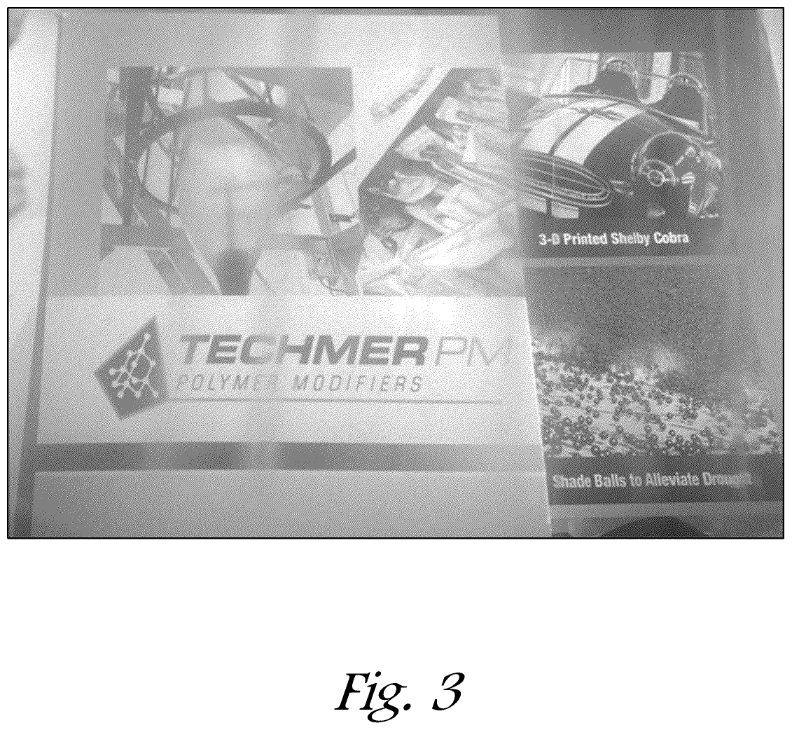

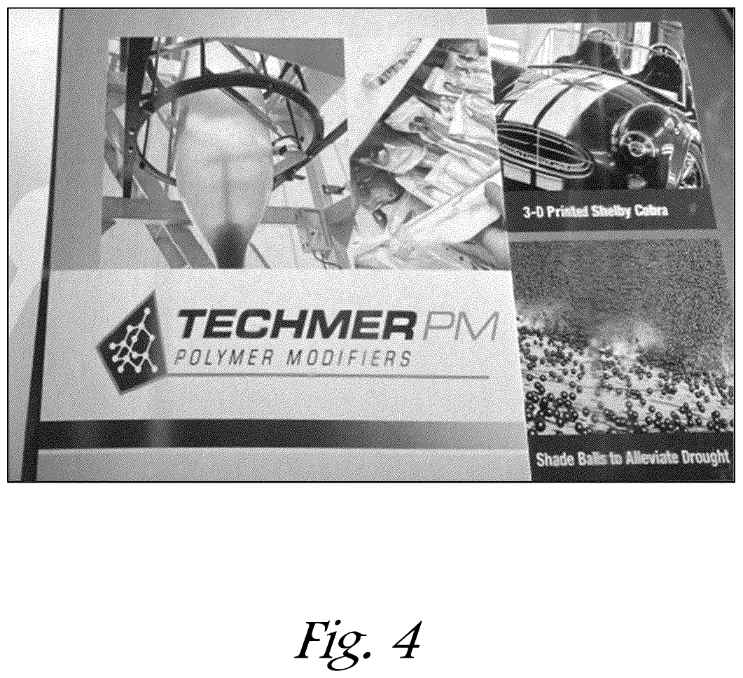

FIGS. 1-4 illustrate film produced without a PPA (FIG. 2), with a standard fluorinated PPA (FIG. 3), and with the non-fluorinated PPA according to an embodiment. Film produced with the non-fluorinated PPA may have increased clarity and fewer visible signs of melt fracture (wavy or thick lines running through the film).

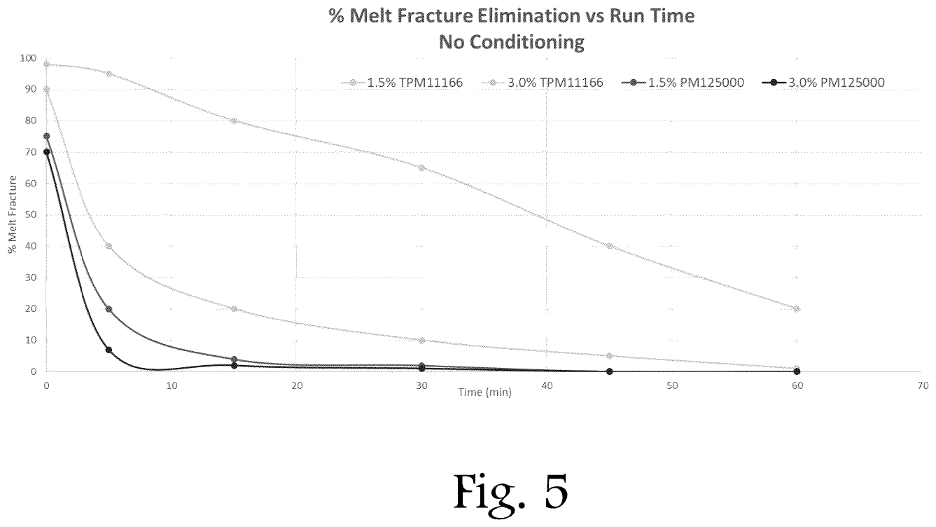

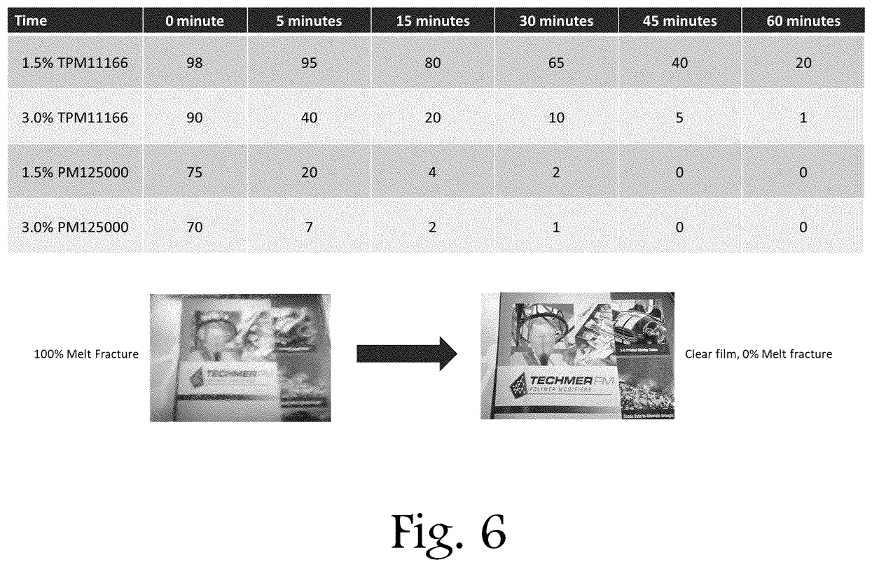

FIGS. 5 and 6 illustrate the difference in time to elimination of melt fracture using a standard fluorinated PPA (TPM11166) versus the non-fluorinated PPA (PM12500) according to an embodiment, and comparing the results to film produced with no PPA. Using the non-fluorinated PPA at a letdown rate of either 1.5% or 3.0% may result in a time to elimination of melt fracture of about 31 to 45 minutes. For example, using the non-fluorinated PPA according to an embodiment may lead to elimination of melt fracture in about 31, 32, 33, 34, 35, 36, 37, 38, 39, 40, 41, 42, 43, 44, or 45 minutes. Melt fracture may also be reduced to a level ranging from about 5 to about 25% within 5 minutes. As shown in FIGS. 5 and 6, when using the non-fluorinated PPA at a letdown rate of 1.5%, the amount of melt fracture observed at 15 mins is about 95% less than when the standard fluorinated PPA is used (80 versus 4). Additionally, the amount of melt fracture observed at 30 mins is about 97% less when using the non-fluorinated PPA as compared with the standard fluorinated PPA (65 versus 2).

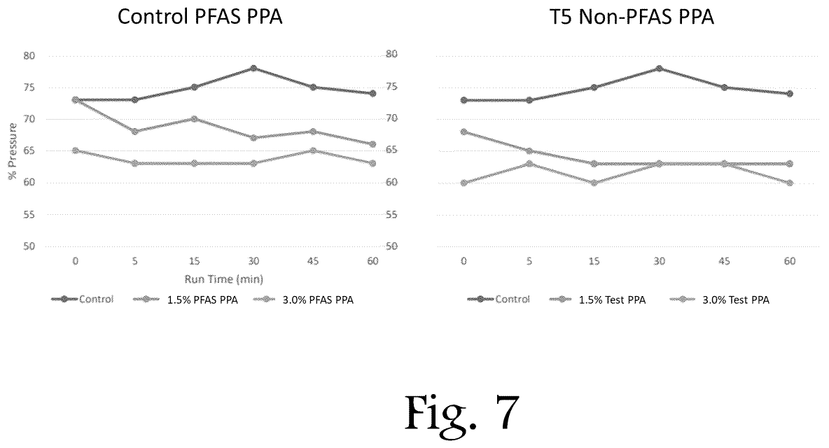

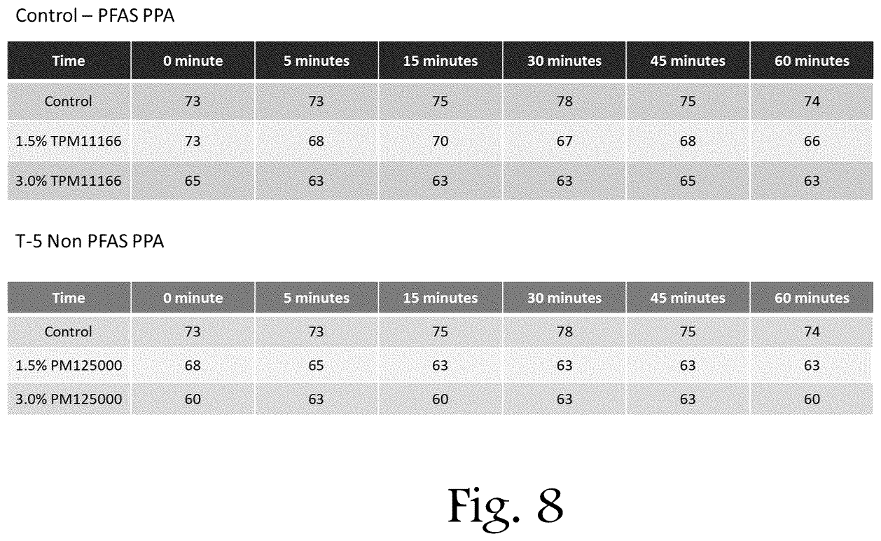

FIGS. 7 and 8 illustrate the percent pressure over the run time for film production utilizing a standard fluorinated PPA (TPM11166) or the non-fluorinated PPA (PM12500) according to an embodiment. The percent pressure may be decreased in film produced using the non-fluorinated PPA as compared to film produced using the fluorinated PPA. The percent pressure for the fluorinated and non-fluorinated PPA films was also compared to a control sample with no PPA (Control).

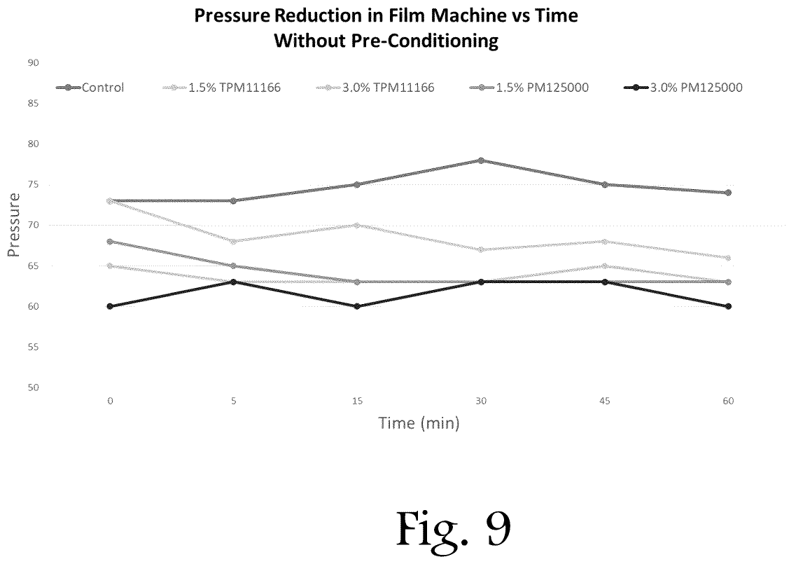

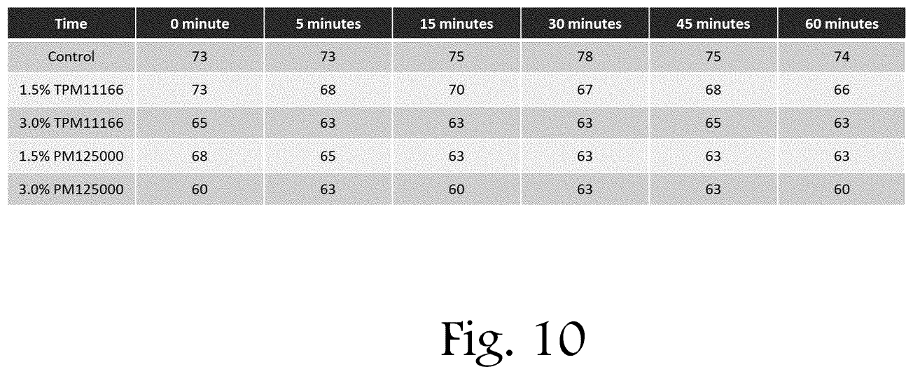

FIGS. 9 and 10 illustrate a reduction in pressure observed over the run time for film produced using the fluorinated or non-fluorinated PPAs as compared to a control resin with no PPA

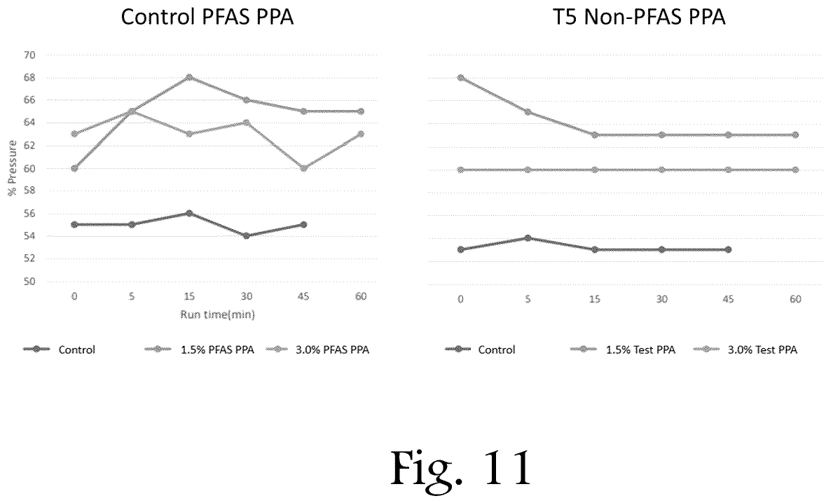

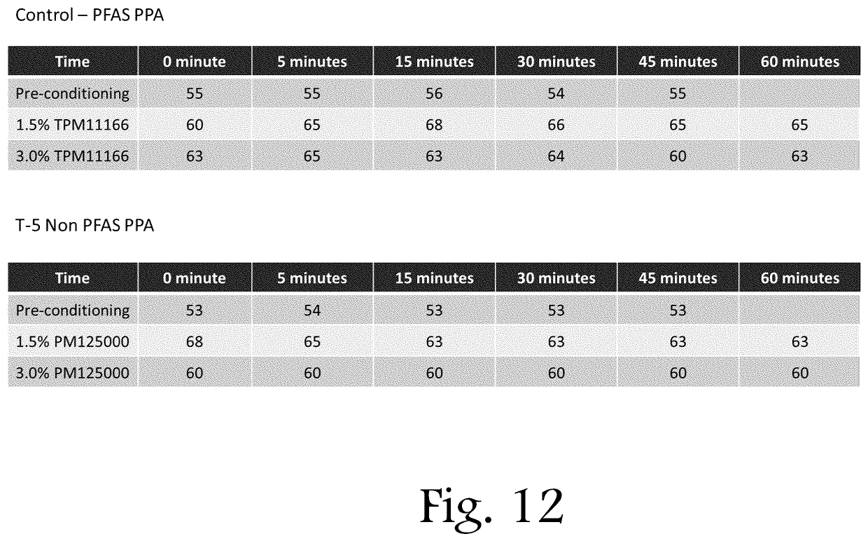

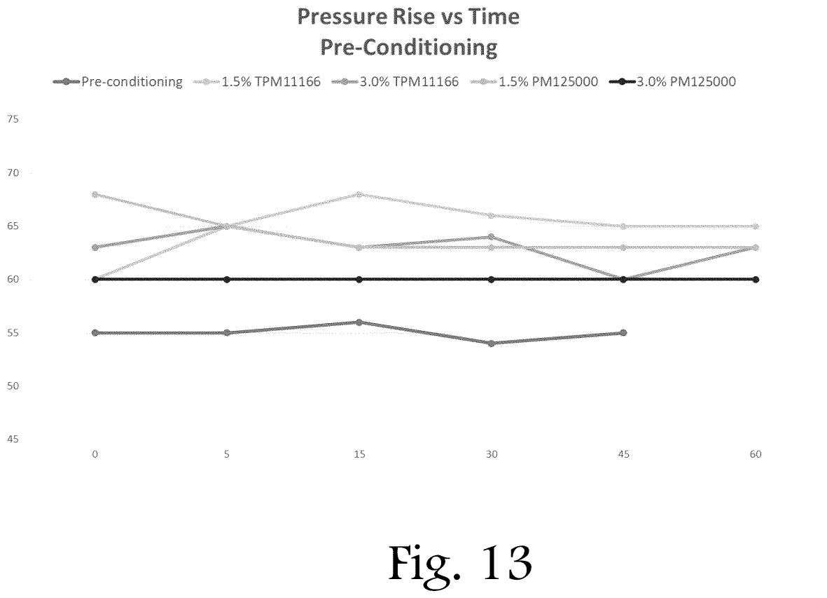

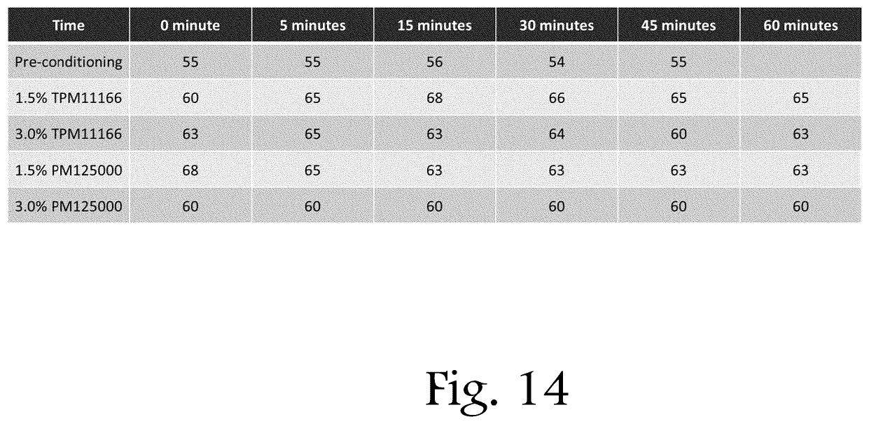

FIGS. 11 through 15 illustrate percent pressure, pressure rise with time, and time to elimination of melt fracture with preconditioning. Preconditioning with either a fluorinated or the non-fluorinated PPA may lead to a reduction in percent pressure and pressure rise with time as compared to film production utilizing the fluorinated or non-fluorinated PPA without preconditioning. Preconditioning with the non-fluorinated PPA according to an embodiment may result in a reduction in time to elimination of melt fracture of about 40 minutes.

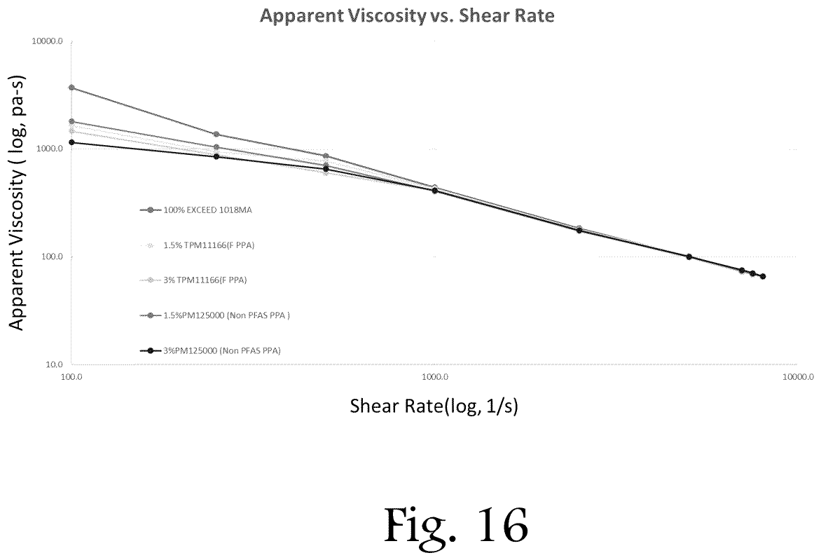

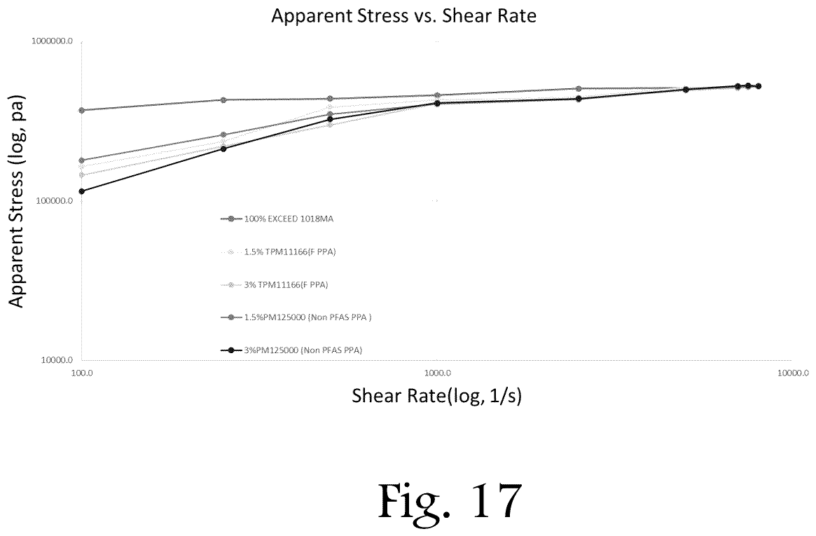

Rheology studies may be used to describe melt flow characteristics of polymers FIGS. 16 and 17 illustrate the results of rheology experiments analyzing the apparent viscosity versus shear rate (FIG. 16) and the apparent stress versus shear rate (FIG. 17).

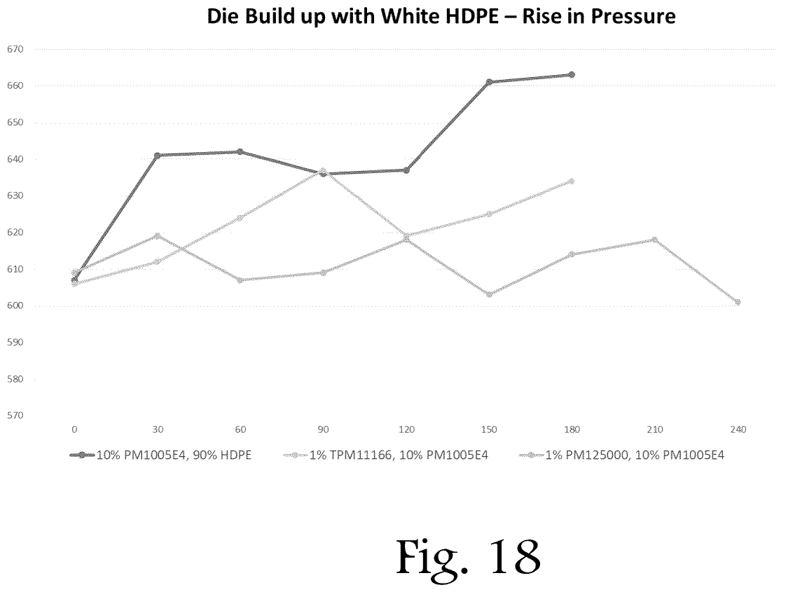

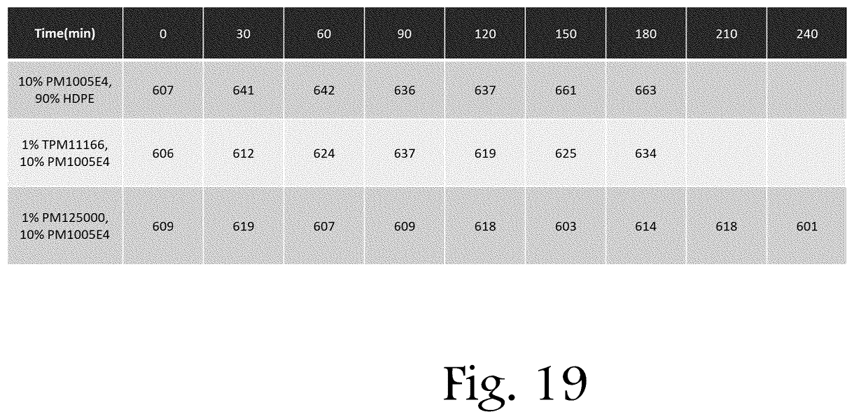

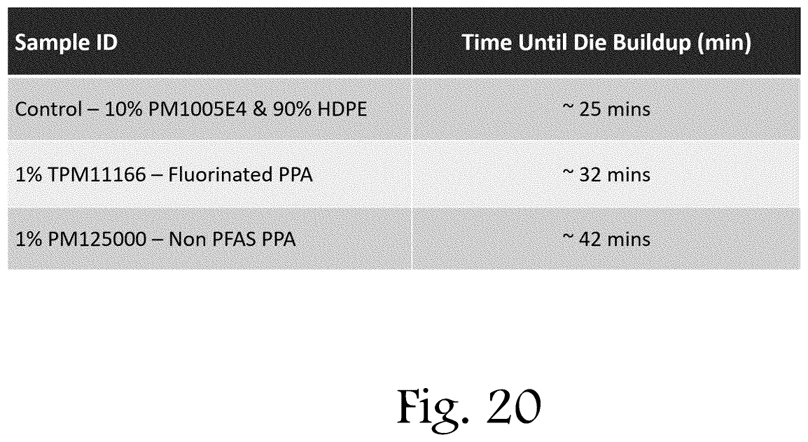

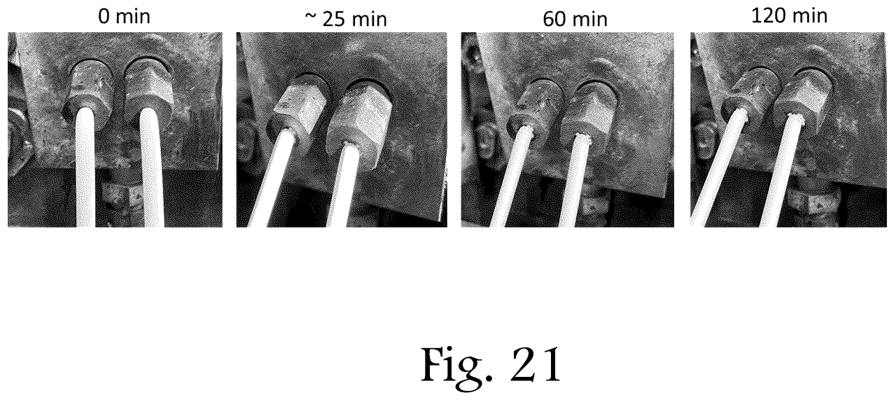

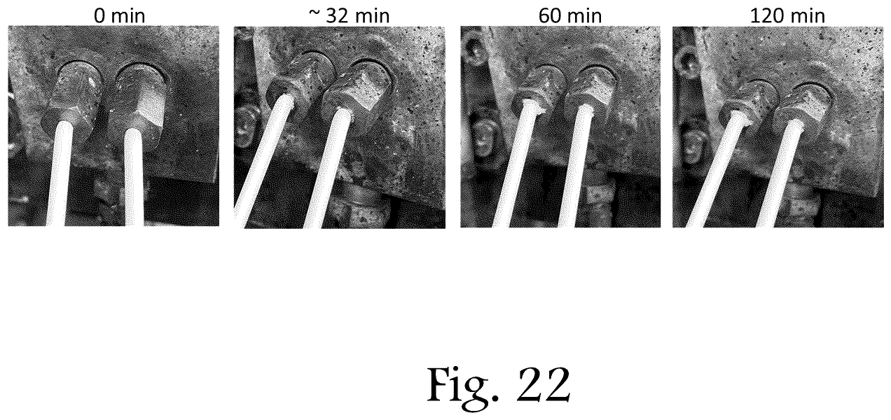

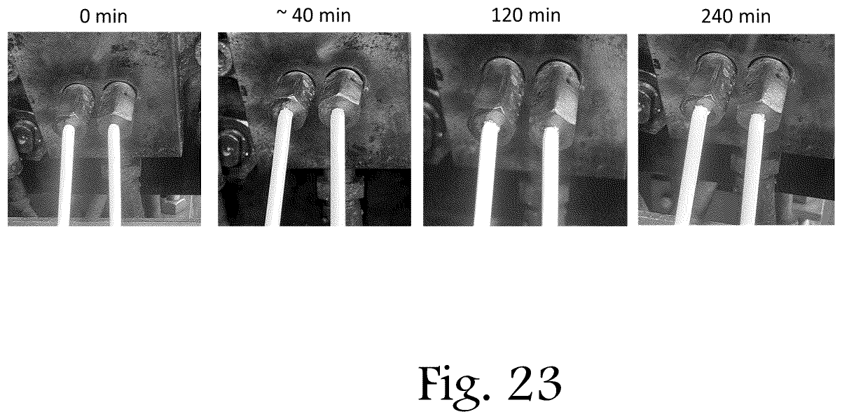

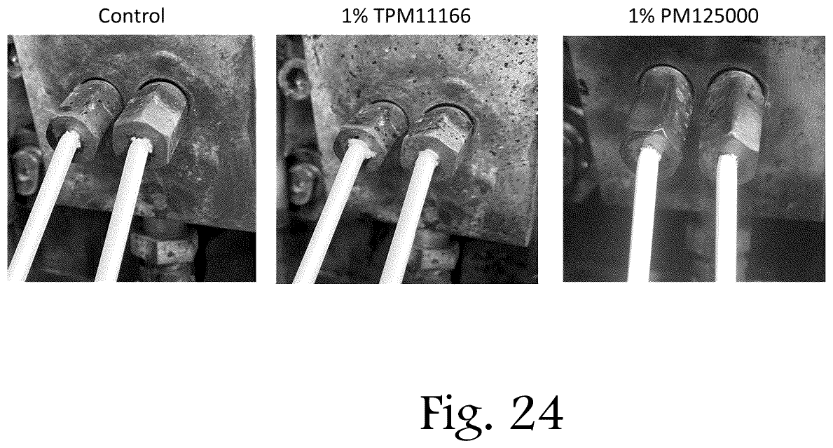

FIGS. 18 through 24 illustrate the results of experiments analyzing die lip buildup using white HDPE alone or with a standard fluorinated PPA or the non-fluorinated PPA according to an embodiment. Use of the non-fluorinated PPA may reduce the rise in pressure over the course of the run time. Use of the non-fluorinated PPA may also reduce the time to die buildup by about 10 minutes as compare to the fluorinated PPA.

FIGS. 25 and 26 illustrate results from experiments testing the retention of tensile strength at break and the retention of elongation at break when UV stabilizer is included with mLLDPE resin alone or with the standard fluorinated PPA or the non-fluorinated PPA according to an embodiment. Use of the non-fluorinated PPA may improve the retention of tensile strength and elongation at break at 1000 hours by about 25% and 50% respectively. These tensile properties were tested according to the methods of ASTM D882.

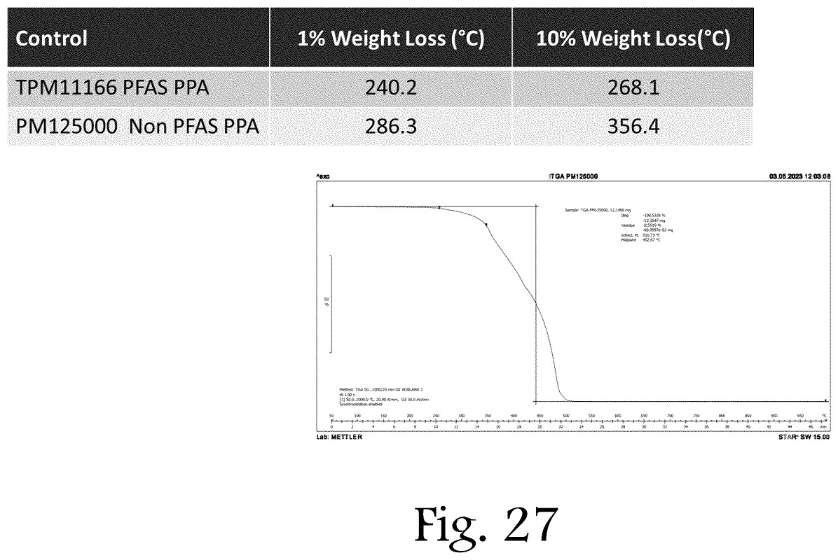

Referring to FIG. 27, the non-fluorinated PPA may exhibit increased thermal stability as compared to the fluorinated PPA. A thermal stability test may determine how resistant a polymer melt is to a change in the molecular structure at the testing temperature. FIG. 27 illustrates the results of a thermal stability test of the fluorinated PPA versus the non-fluorinated PPA. The testing method utilized for these experiments is thermogravimetric analysis according to ASTM E1131, ISO11358. The PPAs were subjected to an increase of 20° C. per minute, and the weight of the pellet was measured. The values show the temperature in degrees Celsius at which the fluorinated PPA and the non-fluorinated PPA lose either 1 or 10 percent molecular weight. Cast film applications may be run at temperatures of about 200 to 270° C. Extrusion coating applications may be run at temperatures of about 250-325° C. The breakdown point in temperature of a PPA used in these applications would therefore need to be greater than about 270° C. As shown in FIG. 27, the non-fluorinated PPA does not exhibit 1% weight loss until well above 270° C. (˜286° C.). The non-fluorinated PPA therefore exhibits increased thermal stability as compared to the standard fluorinated PPA which exhibits 1% weight loss at closer to 240° C. The non-fluorinated PPA may therefore remain thermally stable and exhibit 1% weight loss between about 270° C. and 290° C. The non-fluorinated PPA may exhibit 10% weight loss between about 350° C. and 365° C.

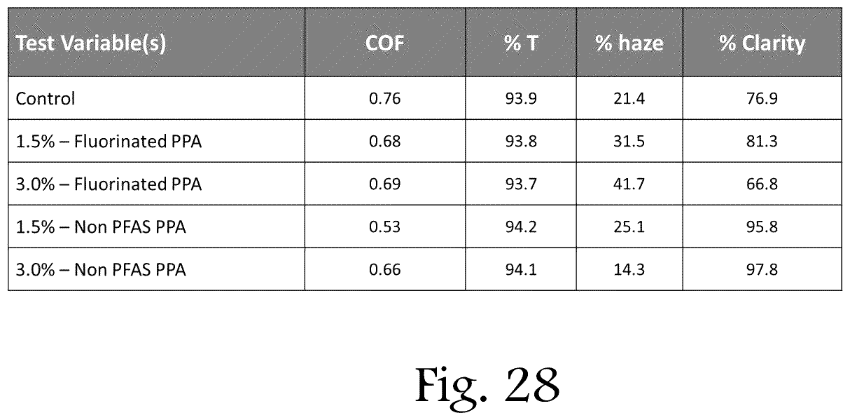

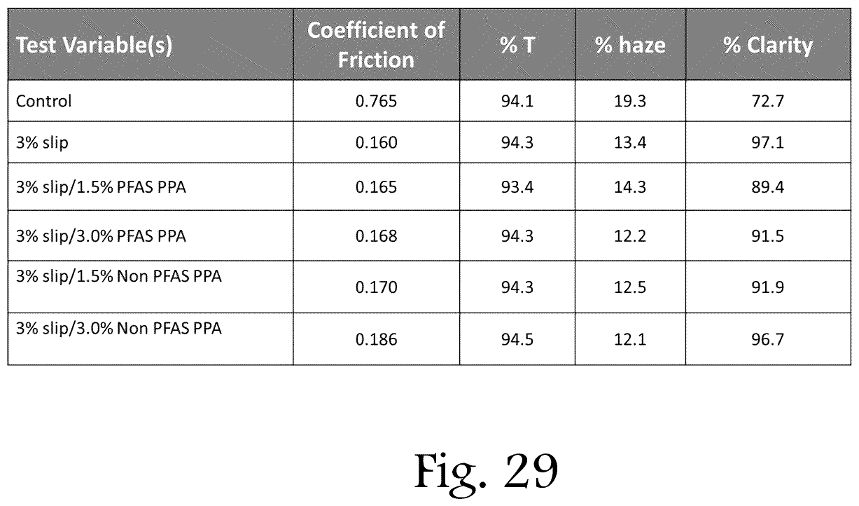

Referring to FIGS. 28 and 29, the non-fluorinated PPA may be used with or further include a slip agent. The slip was included at 3% in a separate line at a letdown rate of 1% in the experiments in these figures. The slip may alternatively be included in the non-fluorinated PPA masterbatch.

The non-fluorinated PPAs may be used in any extruder processes in which sharkskinning or die-lip build-up may occur, including but not limited to cast film, profile extrusion, blow molding, sheet extrusion, fiber and the like. The non-fluorinated PPAs may also be helpful for extruder processes using high temperature or highly filled formulations, such as formulations having high loadings of inorganic materials such as colorants or calcium carbonate, titanium oxide or other mineral fillers such as talc. The non-fluorinated PPAs may be used in extruder processes using a twin screw extruder system, for example. Sharkskin may occur at any temperature and may also occurring formulations without any filler or high solids content. Die lip buildup may be more likely to occur at high temperature and also while using formulations with high filler or solids content in the polymer (e.g. CaCO₃, TiO₂, or other mineral fillers like talc).

### EXAMPLES

### Example 1: Studying Melt Fracture in Blown Film

ExxonMobil Exceed 1018 ethylene 1-hexene copolymer resin with a melt flow rate (MFR) of 1 g/10 min was mixed with either a fluorinated PPA or one of two different non-fluorinated PPAs, and put through a Lab Tech blown film extruder with a length/diameter (L/D) ratio of 24:1. The resulting film was examined for clarity, signs of melt fracture, and the presence of die lines.

Experimental Setup:

| Set temp | 390 | F. |
|---|---|---|
| Actual | 390 | F. |
| Screw RPM | 75 | |
| Nip Roll | 14.2 | |
| Cooling Air | 714 | |
| Take up Speed | 11.1 | ft/sec |
| Run Time | 12 to 15 | minutes |
| Film Thickness | 1 | mil |

Formula Composition:

| Fluorinated PPA: | |
|---|---|
| Polymer Processing Aid | 3% |
| Carrier Resin (LLDPE) | 97% |
| Non-fluorinated PPA 1: | |
| Siloxane polymer (50% in | 20% |
| LDPE) | |
| Synergist (polyethylene glycol) | 4% |
| Carrier Resin (LLDPE) | 76% |
| Non-fluorinated PPA 8: | |
| Organo modified siloxane | 20% |
| Synergist (polyethylene glycol) | 4% |
| Processing Stabilizer | 0.05% |
| (phosphite) | |
| Carrier Resin (LLDPE) | 75.50% |
| Non-fluorinated PPA 2: | |
| Organo modified siloxane | 20% |
| Synergist (polycaprolactone)) | 2% |
| Carrier Resin (LLDPE) | 78% |

Results:

| | | Melt | |
|---|---|---|---|
| PPA added | Clarity | Fracture | Die Lines |
| None | hazy | substantial | substantial |
| Fluorinated PPA 1.5% | hazy | partial | substantial |
| Fluorinated PPA 3.0% | hazy | none | partial |
| Non-fluorinated PPA II | translucent | partial | none |
| 1.5% | | | |
| Non-fluorinated PPA II | clear | none | none |
| 3.0% | | | |
| Non-fluorinated PPA #8 | slightly hazy | partial | partial |
| 1.5% | | | |
| Non-fluorinated PPA #8 | clear | none | none |
| 3.0% | | | |
| Non-fluorinated PPA #1 | slightly hazy | partial | partial |
| 1.5% | | | |
| Non-fluorinated PPA #1 | clear | none | partial |
| 3.0% | | | |

### Example 2: Studying Time to Elimination of Melt Fracture and Pressure Reduction with and without Preconditioning of the Machine

ExxonMobil Exceed 1018 ethylene 1-hexene copolymer resin with a melt flow rate (MFR) of 1 g/10 min was mixed with either a fluorinated PPA or one of two different non-fluorinated PPAs, and put through a Lab Tech blown film extruder with a length/diameter (L/D) ratio of 24:1. Pressure reduction and the time to elimination of melt fracture were measured for each formulation both with and without machine preconditioning with the PPA.

Experimental Setup:

| Set temp | 390 | F. |
|---|---|---|
| Actual | 390 | F. |
| Screw RPM | 50 | |
| Nip Roll | 13.9 | |
| Cooling Air | 461 | |
| Take up Speed | 10.4 | ft/sec |
| Run Time | 12 to 15 | minutes |
| Film Thickness | 1 | mm |

Results without Pre-Conditioning:

Time to Elimination of Melt Fracture

The percentage of melt fracture remaining at each time point was measured.

| Time | 0 min | 5 min | 15 min | 30 min | 45 min | 60 min |
|---|---|---|---|---|---|---|
| Fluorinated | 98 | 95 | 80 | 65 | 40 | 20 |
| PPA 1.5% | | | | | | |
| Fluorinated | 90 | 40 | 20 | 10 | 5 | 1 |
| PPA 3.0% | | | | | | |
| Non-fluorinated | 75 | 20 | 4 | 2 | 0 | 0 |
| PPA 1.5% | | | | | | |
| Non-fluorinated | 70 | 7 | 2 | 1 | 0 | 0 |
| PPA 3.0% | | | | | | |

Pressure

| Time | 0 min | 5 min | 15 min | 30 min | 45 min | 60 min |
|---|---|---|---|---|---|---|
| Control | 73 | 73 | 75 | 78 | 75 | 74 |
| Fluorinated | 73 | 68 | 70 | 67 | 68 | 66 |
| PPA 1.5% | | | | | | |
| Fluorinated | 65 | 63 | 63 | 63 | 65 | 63 |
| PPA 3.0% | | | | | | |
| Non-fluorinated | 68 | 65 | 63 | 63 | 63 | 63 |
| PPA 1.5% | | | | | | |
| Non-fluorinated | 68 | 65 | 63 | 63 | 63 | 63 |
| PPA 3.0% | | | | | | |

Results with Pre-Conditioning

Time to Elimination of Melt Fracture

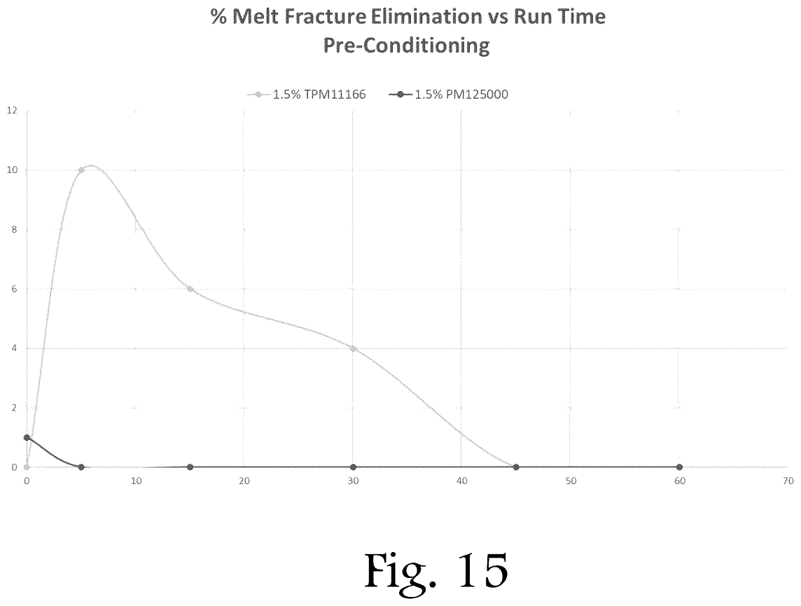

FIG. 15 shows the percent melt fracture present at the indicated time points from 0 to 60 minutes in film processed using either a traditional fluorinated PPA or an example of a non-fluorinated PPA according to an embodiment.

Pressure

| Time | 0 min | 5 min | 15 min | 30 min | 45 min | 60 min |
|---|---|---|---|---|---|---|
| Control | 55 | 55 | 56 | 54 | 55 | |
| Fluorinated | 60 | 65 | 68 | 66 | 65 | 65 |
| PPA 1.5% | | | | | | |
| Fluorinated | 63 | 65 | 63 | 64 | 60 | 63 |
| PPA 3.0% | | | | | | |
| Non-fluorinated | 68 | 65 | 63 | 63 | 63 | 63 |
| PPA 1.5% | | | | | | |
| Non-fluorinated | 60 | 60 | 60 | 60 | 60 | 60 |
| PPA 3.0% | | | | | | |

### Example 3: Measuring Optical Properties of Film Produced with Fluorinated Versus Non Fluorinated PPAs

The percent transmission, haze and clarity of film produced with fluorinated versus non-fluorinated PPAs was measured.

Results:

| PPA added | % Transmission | Haze | Clarity |
|---|---|---|---|
| None | 93.9 | 21.4 | 76.9 |
| Fluorinated PPA 1.5% | 93.8 | 31.5 | 81.3 |
| Fluorinated PPA 3.0% | 93.7 | 41.7 | 66.8 |
| Non-fluorinated PPA II | 93.9 | 15.4 | 94.9 |
| 1.5% | | | |
| Non-fluorinated PPA II | 93.8 | 12 | 98.5 |
| 3.0% | | | |
| Non-fluorinated PPA #8 | 94.2 | 25.1 | 95.8 |
| 1.5% | | | |
| Non-fluorinated PPA #8 | 94.1 | 14.3 | 97.8 |
| 3.0% | | | |

### Example 4: Capillary Rheometry Studies

Capillary rheometry studies were done according to ASTM D3835 with a 10-minute melt time, CX400-20 die (1.016 mm diameter, 20.32 mm length, and 120° angle). F-PPA indicates a traditional fluorinated processing aid. NF-PPA indicates a non-fluorinated PPA according to an embodiment.

Results for Viscosity:

| | 100 | 250 | 500 | 1000 | 2500 | 5000 | 7000 | 7500 | 8000 |
|---|---|---|---|---|---|---|---|---|---|
| Control | 3692 | 1360.7 | 856.3 | 437.2 | 183 | 100.8 | 72.6 | 68.7 | 65.7 |
| 1.5% F-PPA | 1643.7 | 941 | 774.1 | 428.8 | 179.2 | 102.4 | 74.8 | 70.3 | 66.3 |
| 3% F-PPA | 1453.2 | 876.5 | 598 | 408 | 174.4 | 97.8 | 72.6 | 68.4 | 64.7 |
| 1.5% NF-PPA | 1794.9 | 1038.8 | 699.4 | 404.3 | 172.9 | 100 | 73.6 | 69.1 | 65.3 |
| 3% NF-PPA | 1146.4 | 844.2 | 647.2 | 409.1 | 174.7 | 99.6 | 74.8 | 70.3 | 65.3 |

Results for Stress:

| | 100 | 250 | 500 | 1000 | 2500 | 5000 | 7000 | 7500 | 8000 |
|---|---|---|---|---|---|---|---|---|---|
| Control | 340172.3 | 369197.5 | 428136.9 | 437155.7 | 457543.2 | 504097.8 | 507908.5 | 515212.4 | 525946 |
| 1.5% F-PPA | 164370 | 235249.9 | 387044.4 | 428772.1 | 447952.8 | 511846.3 | 523278.5 | 527025.7 | 530582.4 |
| 3% F-PPA | 145316.3 | 219117.7 | 299016.3 | 408003.6 | 436076 | 488918.3 | 507908.5 | 513370.6 | 517816.4 |
| 1.5% NF-PPA | 179486 | 259702.1 | 349699.2 | 404319.9 | 432138.2 | 499905.9 | 515212.4 | 518324.5 | 522135.3 |
| 3% NF-PPA | 114639.9 | 211051.6 | 323595.6 | 409146.8 | 436647.6 | 497810 | 523913.6 | 527470.3 | 522135.3 |

### Example 5

Studying Die Buildup Occurring with White HDPE:

90% HDPE HHM5502 (an ethylene-hexene copolymer) resin plus 10% White M/B (white plus 50% zinc stearate) as a control; or HDPE HHM5502 plus White M/B plus either a fluorinated PPA or a non-fluorinated PPA was put through a Coperion 18 mm twin screw extruder with a length/diameter ration of 24:1. The time to die buildup, presence of die buildup and pressure raise were measured. Transmission haze testing was done according to ASTM D1003 methods.

Results:

| Test Variable(s) | COF | % T | % haze | % Clarity |
|---|---|---|---|---|
| Control (No slip, no PPA) | 0.765 | 94.2 | 18.8 | 77.0 |
| 3% slip agent - reduces COF | 0.160 | 94.4 | 10.7 | 98.2 |
| 3% Slip agent/1.5% Traditional PPA | 0.165 | 93.5 | 10.1 | 86.5 |
| 3% Slip agent/3% Traditional PPA | 0.168 | 94.3 | 11.6 | 90.6 |
| 3% Slip agent/1.5% Non-fluorinated | 0.170 | 94.3 | 15.1 | 87.9 |
| PPA | | | | |
| 3% Slip agent/3.0% Non-fluorinated | 0.186 | 94.4 | 13.0 | 97.6 |
| PPA | | | | |

### Example 6: Comparison of Process Using Fluorinated Versus Non Fluorinated PPA

| Parameter | Old fluorinated product | New development |
|---|---|---|
| Product chemistry | Fluoroelastomer + synergist | Siloxane + synergist |
| Potential synergist | Polyethylene glycol or | Polyethylene glycol or |
| | polycaprolatone | polycaprolatone |
| Raw material loading | Typically 1-3% in | New product is loaded |
| in our product | polyethylene | 15-25% |
| Usage level of our | Typically 0.5-3% | Typically 0.5-3% |
| product at customer | | |
| Processing method to | Typically twin screw | Typically twin screw |
| make our product | extruder | extruder |
| Processing temperatures | 140-180° C. | 140-180° C. |
| Shear used to produce | Low-Medium | High |
| our product | | |
| Film production | No difference between | No difference between |
| | products | products |
| Die lip build-up reduction | Typically 1-5% | Typically 0.5-3% |
| usage level of our product | | |

### Example 7: Suitable Amounts of Optional Additives for Use in or with the Non-Fluorinated PPA

The optional additives described below may be added to the non-fluorinated PPA composition during mixing, or may be added as a separate masterbatch (MB) or included in a resin along with the masterbatch including the non-fluorinated PPA. For example, any of the optional additives described below may be included on its own or in combination with any other of the optional additives in the non-fluorinated PPA composition. The composition including the optional additives may be provided as a single masterbatch.

| Chemistry | Typical Usage level | Typically used in | Added as |
|---|---|---|---|
| Antiblock - Talc, DE, | 500-10000 ppm | Skin (outer layer) | Along with our additives or as a |
| silica, minbloc, | | | separate MB or available in resin |
| CaCO3 | | | |
| Slip - Oleamide, | 1000 ppm to 5000 ppm | skin | Along with our additives or as a |
| Erucamide | | | separate MB or available in resin |
| White - TiO2, ZnS | 0.25% to 20% | All layer, or | Along with our additives or as a |
| | | designated layer | separate MB |
| Black - Carbon | 0.1 to 5% | All layer, or | Along with our additives or as a |
| black, iron oxide | | designated layer | separate MB |
| Colorants - Blue, | 0.05 to 10% | All layer, or | Along with our additives or as a |
| yellow, green, | | designated layer | separate MB |
| orange, red, organics | | | |
| pigments, inorganic | | | |
| pigments | | | |
| Antifog | 0.25% to 2% | Skin and Core | Along with our additives or as a |
| polyglycerol ester, | | | separate MB |
| GMS, GMO, | | | |
| Sorbitan ester, | | | |
| Ethoxylated Amine, | | | |
| Ethoxylated alcohol | | | |
| UV stabilizers and | 0.1% to 2% | All layer, or | Along with our additives or as a |
| absorber - secondary | | designated layer | separate MB |
| and tertiary HALS, | | | |
| Benzophenone, | | | |
| Benzyl triazole, | | | |
| inorganic absorbers, | | | |
| benzoate Ester, | | | |
| Benzyl triazine | | | |

### Example 8: Testing the Ratio of Organo Modified Siloxane to Synergist in the Non-Fluorinated PPA on the Viscosity of the Melt and the Incorporation of the Additives into the Resin

Three compositions of the non-fluorinated PPA comprising different ratios of organo modified siloxane to synergist were tested for melting and incorporation of the additives into the resin. A ratio of about 1:4 produced a resin with optimal melt properties and homogeneous incorporation of the additives into the resin.

Composition #1:

| Component | Amount (wt %) |
|---|---|
| Organo modified Siloxane | 18% |
| Synergist | 6% |
| Resin | 2% |
| Antioxidant | 74% |

Results:

The composition exhibited low viscosity and poor incorporation.

Composition #2:

| Component | Amount (wt %) |
|---|---|
| Organo modified Siloxane | 16% |
| Synergist | 8% |
| Resin | 2% |
| Antioxidant | 74% |

Results:

The composition exhibited low viscosity and poor incorporation. It was not fully incorporated and was not homogeneous.

Composition #3:

| Component | Amount (wt %) |
|---|---|
| Organo modified Siloxane | 20% |
| Synergist | 4% |
| Resin | 2% |
| Antioxidant | 74% |

Results:

The composition was soft when melted but exhibited good incorporation of the additives.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A polymer processing aid composition comprising:
an organo modified siloxane;
a synergist; and
a carrier resin.

2. The polymer processing aid composition of claim 1, wherein the organo modified siloxane and the synergist are included in the composition at a weight ratio of from 4:1 to 5:1 organo modified siloxane to synergist.

3. The polymer processing aid composition of claim 2, wherein the synergist is polyethylene glycol.

4. The polymer processing aid composition of claim 2, wherein the carrier resin is linear low density polyethylene (LLDPE).

5. The polymer processing aid composition of claim 2, further comprising an antioxidant.

6. The polymer processing aid composition of claim 5, wherein the antioxidant is a phosphite.

7. A polymer processing aid composition comprising:
15-25% by weight of an organo modified siloxane;
3-5% by weight of a synergist; and
70-85% by weight of a carrier resin.

8. The polymer processing aid of claim 7, further comprising 0.02-0.1% by weight of an antioxidant.

9. The polymer processing aid of claim 7, wherein the organo modified siloxane and the synergist are included in the composition at a ratio of from 4:1 to 5:1 organo modified siloxane to synergist.

10. The polymer processing aid of claim 8, wherein the synergist is polyethylene glycol.

11. The polymer processing aid of claim 7, wherein the polymer processing aid has a thermal stability at 1% weight loss as measured by ASTM E1131, ISO11358 of 275-290° C.

12. The polymer processing aid of claim 8, further comprising a UV stabilizer and/or a slip agent.

13. The polymer processing aid of claim 8, wherein the polymer processing aid when present in a first plastic composition at a letdown rate of 1.5% results in the plastic composition having a time to elimination of melt fracture for a blown film of at least 15 minutes less than a second plastic composition similar in all respects to the first plastic composition except having a second polymer processing aid, different than the polymer processing aid.

14. A method for forming a masterbatch comprising:
mixing an organo modified siloxane, a synergist, and one or more additives, with a carrier resin to form a mixture;
heating the mixture; and
applying a shear stress to the mixture to promote uniform blending.

15. The method of claim 14, wherein the one or more additives is an antioxidant.

16. The method of claim 14, wherein the carrier resin is a polyethylene resin.

17. The method of claim 14, wherein the carrier resin is a polypropylene resin.

18. The method of claim 14, wherein the one or more additives is a white and a slip agent.

19. The method of claim 14, wherein the one or more additives is a hindered light amine stabilizer and a UV absorber.

20. The method of claim 14, wherein inclusion of the masterbatch at a letdown rate of 1.5% improves clarity as measured by ASTM D1003 of a blown film by at least 25% as compared to a blown film produced without the masterbatch.
